(19) United States
(12) Patent Application Publication
(10) Pub. No.: US 2025/0095190 A1
(43) Pub. Date: Mar. 20, 2025

(54) METHOD, COMPUTING DEVICE, AND RECORDING MEDIUM FOR DETECTING OBJECT IN REAL TIME BASED ON LIDAR POINT CLOUD

(71) Applicant: RideFlux Inc., Jeju-si (KR)

(72) Inventors: Hawook JEONG, Seoul (KR); Sangwon JEONG, Seoul (KR); Beomjun PARK, Jeju-si (KR)

(73) Assignee: RideFlux Inc., Jeju-si (KR)

(21) Appl. No.: 18/886,288

(22) Filed: Sep. 16, 2024

(30) Foreign Application Priority Data
Sep. 20, 2023 (KR) 10-2023-0125483

(51) Int. Cl. G06T 7/70; G01S 17/89; G06V 10/44; G06V 10/764; G06V 10/771; G06V 10/80

(52) U.S. Cl. CPC G06T 7/70; G01S 17/89; G06V 10/44; G06V 10/764; G06V 10/771; G06V 10/806; G06T 2207/10028; G06V 2201/07

(57) ABSTRACT

Provided are a method, computing device, and recording medium for detecting an object in real time on the basis of a lidar point cloud. The method is performed by the computing device and includes generating a feature map on the basis of a point cloud which is generated by scanning a certain region through a lidar sensor and deriving an object detection result by inputting the generated feature map to a pretrained object detection model.

### CROSS-REFERENCE TO RELATED APPLICATION

This application claims priority to and the benefit of Korean Patent Application No. 10-2023-0125483, filed on Sep. 20, 2023, the disclosure of which is incorporated herein by reference in its entirety.

### BACKGROUND

### 1. Field of the Invention

The present invention relates to a method, device, and recording medium for detecting an object in real time on the basis of a lidar point cloud.

### 2. Discussion of Related Art

For the convenience of users who drive vehicles, the vehicles are increasingly equipped with various sensors and electronics such as an advanced driver assistance system (ADAS). In particular, technology is actively being developed for an autonomous driving system of a vehicle that recognizes its surroundings and is driven by itself to a given destination in accordance with the recognized surroundings without a driver's intervention.

An autonomous vehicle is a vehicle with an autonomous system function for recognizing its surroundings without a driver's intervention and is automatically driven by itself to a given destination in accordance with the recognized surroundings, and the autonomous driving system function is performing localization, recognition, prediction, planning, and control for autonomous driving.

An autonomous driving system processes point cloud data acquired from a sensor (e.g., a lidar sensor) to detect an object nearby an autonomous vehicle through a recognition process and receives recognition results (e.g., information such as the location, attitude, speed, and the like of the object) derived from the recognition process to generate a driving plan such as the route, speed, and the like of the autonomous vehicle.

### SUMMARY OF THE INVENTION

In autonomous driving systems, an object detection technology employed in a recognition process is a necessary technology for autonomous driving control.

In autonomous driving systems, object detection is generally performed by analyzing sensor data collected through sensors provided in autonomous vehicles. There are main types of object detection methods: object detection employing a camera, object detection employing a radar sensor, and object detection employing a lidar sensor.

First, object detection employing a camera is a method of detecting an object by analyzing an image captured through a camera. According to this method, two-dimensional (2D) detection is easy, but it is difficult to determine a depth of a detected object. To address this problem, several cameras are used to estimate a range, or range information is separately computed through matching with a radar. However, these are relatively inaccurate methods.

Second, object detection employing a radar sensor is a method of detecting an object using radar sensor data. While the radar sensor is extremely weather-resistant and has good distance resolution, the radar sensor has poor object detection performance due to very low precision and inability of determining a type of object.

The present invention is directed to providing a device, method, and recording medium for detecting an object in real time on the basis of a lidar point cloud which may allow real-time object detection and ensure superior detection performance and speed by generating a feature map on the basis of a point cloud collected through a lidar sensor and detecting an object on the basis of the feature map.

Objects to be solved by the present invention are not limited to that described above, and other objects which have not been described will be clearly understood by those of ordinary skill in the art from the following description.

According to an aspect of the present invention, there is provided a method of detecting an object in real time on the basis of a lidar point cloud, which is performed by a computing device, the method including generating a feature map on the basis of a point cloud which is generated by scanning a certain region through a lidar sensor and deriving an object detection result by inputting the generated feature map to a pretrained object detection model.

The generating of the feature map may include generating a first feature map by processing the point cloud on the basis of deep learning, generating a second feature map by processing the point cloud on the basis of rules, and generating an input feature map of the pretrained object detection model by combining the generated first feature map and the generated second feature map.

The generating of the first feature map may include generating a range image by converting three-dimensional (3D) points included in the point cloud into two-dimensional (2D) points on a YZ plane on the basis of a range of the lidar sensor or a vehicle in which the lidar sensor is installed, extracting feature information by analyzing the generated range image on the basis of a deep-learning-based feature extraction module and generating a range feature map using the extracted feature information, and generating a first feature map in the form of a bird's eye view (BEV) by projecting the generated range feature map on an XY plane.

The generating of the first feature map in the form of a BEV may include generating a plurality of lattices by latticing a region having a preset range on the XY plane and recording feature information of points included in the generated range feature map in each of the plurality of lattices.

The recording of the feature information of the points in each of the plurality of lattices may include generating a plurality of unit lattices for each of the plurality of generated lattices by dividing the lattice to a certain size and recording feature information of points, which are included in the generated range feature map and correspond to a specific one of the plurality of lattices, in each of the plurality of unit lattices generated by dividing the specific lattice.

The recording of the feature information in each of the plurality of unit lattices generated by dividing the specific lattice may include recording only feature information of one point corresponding to the plurality of unit lattices generated by dividing the specific lattice and, when two or more points correspond to a specific unit lattice, recording only feature information of any one of the two or more points in the specific unit lattice.

The generating of the range image may include determining a size of a range image to be generated on the basis of an attribute of the lidar sensor which includes at least one of the number of channels and laser radiation intervals.

The generating of the range image may include generating a range image in the form of a 2D tensor by converting the 3D points included in the point cloud into 2D points on the YZ plane, generating range images in the form of a plurality of 2D tensors by recording a plurality of pieces of information about each of the 3D points in each of range images having different forms of 2D tensors in accordance with kinds of information, and a range image in the form of one 3D tensor by combining the range images generated in the form of the plurality of 2D tensors, the generating of the range feature map includes generating a range feature map in the form of one 3D tensor using the generated range image having the form of one 3D tensor, and the generating of the first feature map includes generating a first feature map in the form of a 3D tensor using the generated range feature map having the form of one 3D tensor.

The generating of the second feature map may include generating a BEV image by projecting the point cloud or a range image generated on the basis of the point cloud on an XY plane and extracting feature information by analyzing the generated BEV image on the basis of a rule-based feature extraction module and generating a second feature map in the form of a BEV using the extracted feature information.

The generating of the BEV image may include generating a plurality of lattices by latticing a region having a preset size on the XY plane and recording feature information of points included in the point cloud or the range image generated on the basis of the point cloud in each of the plurality of generated lattices.

The generating of the feature map may include generating a range image by converting 3D points included in the point cloud into 2D points on a YZ plane on the basis of a range of the lidar sensor or a vehicle in which the lidar sensor is installed, extracting first feature information by analyzing the generated range image on the basis of a deep-learning-based feature extraction module and generating a range feature map using the extracted first feature information, combining the point cloud or the generated range image with the generated range feature map and then projecting the combination on an XY plane to generate a first BEV feature map, and extracting second feature information by analyzing the generated first BEV feature map through a rule-based feature extraction module and generating a second BEV feature map as an input feature map of the pretrained object detection model using the extracted second feature information.

The pretrained object detection model may include a deep-learning-based image analysis model, and the deriving of the object detection result may include determining one of a plurality of predefined classes to which an object belongs by analyzing the generated feature map through the deep-learning-based image analysis model and deriving an object detection result including information about the determined class and information about the object wherein, when the object is a pedestrian, the information about the object may include location information of the pedestrian, and when the object is a vehicle, the information about the object may include information about a location of the vehicle and a distance from the vehicle.

According to another aspect of the present invention, there is provided a computing device for performing a method of detecting an object in real time on the basis of a lidar point cloud, the computing device including a processor, a network interface, a memory, and a computer program loaded to the memory and executed by the processor. The computer program includes an instruction of generating a feature map on the basis of a point cloud which is generated by scanning a certain region through a lidar sensor and an instruction of deriving an object detection result by inputting the generated feature map to a pretrained object detection model.

According to another aspect of the present invention, there is provided a computer program stored in a computer-readable recording medium to perform a method of detecting an object in real time on the basis of a lidar point cloud in combination with a computing device, the method including generating a feature map on the basis of a point cloud which is generated by scanning a certain region through a lidar sensor and deriving an object detection result by inputting the generated feature map to a pretrained object detection model.

Other details of the present invention are included in the detailed description and drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram of an autonomous driving system according to an exemplary embodiment of the present invention;

FIG. 2 shows a hardware block diagram of a computing device that performs a method of detecting an object in real time on the basis of a point cloud according to another exemplary embodiment of the present invention;

FIG. 3 is a flowchart illustrating a method of detecting an object in real time on the basis of a lidar point cloud according to still another exemplary embodiment of the present invention;

FIG. 4 is a flowchart illustrating an input feature map generation method according to a first exemplary embodiment;

FIG. 5 is a diagram illustrating the input feature map generation method according to the first exemplary embodiment;

FIG. 6 is a flowchart illustrating a method of generating a first feature map according to various embodiments;

FIG. 7 is a diagram illustrating a range image that is applicable to various embodiments;

FIG. 8 is a diagram illustrating a range feature map that is applicable to various embodiments;

FIG. 9 is a diagram illustrating a deep-learning-based feature extraction model for extracting a range feature map from a range image according to various embodiments;

FIG. 10 is a diagram illustrating a first feature map in the form of a bird's eye view (BEV) that is applicable to various embodiments;

FIG. 11 is a diagram illustrating a process of projecting a range image or a range feature map according to various embodiments;

FIG. 12 is a flowchart illustrating a method of generating a second feature map according to various embodiments;

FIG. 13 is a diagram illustrating an input feature map that is applicable to various embodiments;

FIG. 14 is a flowchart illustrating an input feature map generation method according to a second exemplary embodiment;

FIG. 15 is a diagram illustrating the input feature map generation method according to the second exemplary embodiment; and

FIGS. 16A and 16B are sets of views illustrating object detection results based on a camera image and an object detection result based on lidar point cloud according to various embodiments.

### DETAILED DESCRIPTION OF EXEMPLARY EMBODIMENTS

Advantages and features of the present invention and methods of achieving them will become apparent with reference to exemplary embodiments described in detail below in conjunction with the accompanying drawings. However, the present invention is not limited to the embodiments disclosed below but may be implemented in various different forms, and the embodiments are only provided to make the present disclosure complete and fully convey the scope of the invention to those of ordinary skill in the art to which the present disclosure pertains. The present invention is only defined by the scope of claims.

Terms used herein are not for limiting the present invention but for describing the embodiments. In this specification, singular forms include plural forms as well unless the context clearly indicates otherwise. The term “comprises” and/or “comprising” used herein does not exclude the presence or addition of one or more components other than a mentioned component. Throughout the specification, like reference numbers refer to like components, and the term “and/or” includes each and all combinations of one or more of mentioned items. Although the terms “first,” “second,” and the like are used for describing various components, these components are not limited by the terms. These terms are only used for distinguishing one component from others. Accordingly, a first component described below may be a second component within the technical scope of the present invention.

Unless otherwise defined, all terms (including technical and scientific terms) used herein may be used in a meaning that may be commonly understood by those skilled in the art to which the present invention pertains. In addition, terms that are defined in commonly used dictionaries are not ideally or excessively interpreted unless specifically defined clearly.

The term “unit” or “module” used herein refers to a software component or a hardware component, such as a field programmable gate array (FPGA) or an application-specific integrated circuit (ASIC), and a “unit” or a “module” performs a certain role. However, a “unit” or a “module” is not limited to software or hardware. A “unit” or a “module” may be configured to be in an addressable storage medium or configured to run one or more processors. Accordingly, for example, a “unit” or a “module” includes components, such as software components, object-oriented software components, class components, and task components, processes, functions, attributes, procedures, subroutines, segments of a program code, drivers, firmware, microcode, circuits, data, databases, data structures, tables, arrays, and variables. Functions provided by components and “units” or “modules” may be combined into fewer components and “units” or “modules” or subdivided into additional components and “units” or “modules.”

Spatially relative terms, such as “below,” “beneath,” “lower,” “above,” “upper,” and the like, may be used for easily describing the correlation between a component and other components as shown in the drawings. Spatially relative terms should be understood as terms including different directions of components during use or operation in addition to the directions shown in the drawings. For example, when a component shown in the drawings is turned over, another component described as “below” or “beneath” the component may be placed “above” the component. Accordingly, the exemplary term “below” may include both directions below and above. Components may be oriented in other directions, and thus spatially relative terms may be interpreted in accordance with orientation.

As used herein, the term “computer” indicates any type of hardware device including at least one processor and may be understood as including a software element running on a corresponding hardware device according to an embodiment. For example, a computer may be understood as including, but is not limited to, a smartphone, a tablet personal computer (PC), a desktop computer, a laptop computer, and a user client and an application running on each device.

Hereinafter, exemplary embodiments of the present invention will be described in detail with reference to the accompanying drawings.

Operations described herein will be described as being performed by a computer, but a subject of each operation is not limited thereto, and at least some operations may be performed by different devices according to an embodiment.

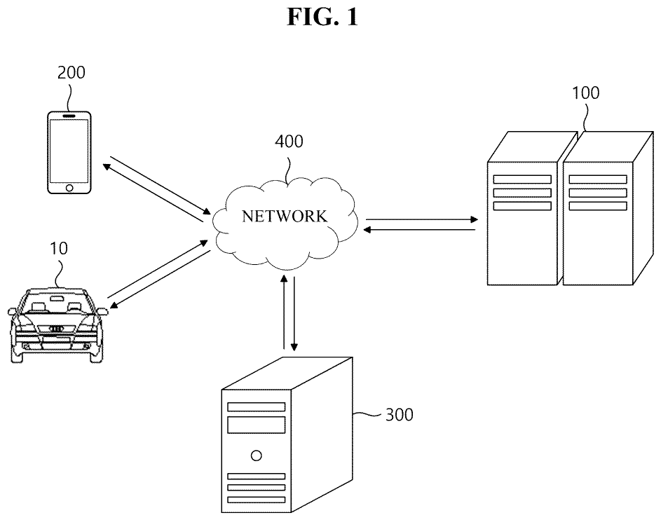

FIG. 1 is a diagram of an autonomous driving system according to an exemplary embodiment of the present invention.

Referring to FIG. 1, an autonomous driving system according to an exemplary embodiment of the present invention may include a computing device 100, a user terminal 200, an external server 300, and a network 400.

The autonomous driving system shown in FIG. 1 is in accordance with an exemplary embodiment, and the components are not limited to the embodiment shown in FIG. 1 and may be added, changed, or removed as necessary.

In an exemplary embodiment, the computing device 100 may control autonomous driving of a vehicle 10. To this end, the computing device 100 may perform a localization operation, a recognition operation, a planning operation, and a control operation.

According to the autonomous driving system shown in FIG. 1, the computing device 100 may be separately provided outside the vehicle 10, determine a control command related to autonomous driving at the outside of the vehicle 10, and transmit the control command related to autonomous driving to the vehicle 10 such that the vehicle 10 performs an autonomous driving operation. However, the computing device 100 is not limited thereto. The computing device 100 may correspond to one of components provided in the vehicle 10 and control autonomous driving of the vehicle 10 by determining a control command related to autonomous driving in the vehicle 10 and directly controlling components of the vehicle 10 in accordance with the control command related to autonomous driving. For example, the computing device 100 may be a control module for controlling, in the vehicle 10, operations of components included in the vehicle 10.

First, the localization operation performed by the computing device 100 may be an operation of measuring the location and attitude of the vehicle 10. For example, the computing device 100 may collect sensor data (e.g., point cloud data, image data, and the like) by scanning surroundings of the vehicle 10 using a sensor provided in the vehicle 10 and calculate a position measurement value corresponding to the location and attitude of the vehicle 10 using the collected sensor data.

Second, the recognition operation performed by the computing device 100 may be an operation of detecting an object nearby the vehicle 10. For example, the computing device 100 may recognize an object existing nearby the vehicle 10 by analyzing sensor data collected by scanning the surroundings of the vehicle 10.

According to various embodiments, the computing device 100 may generate a feature map on the basis of a point cloud, which is generated by scanning a certain region through a lidar sensor installed in the vehicle 10, and derive an object detection result by inputting the feature map to a pretrained object detection model.

The object detection model (e.g., a neural network) may include one or more network functions, which may be a set of interconnected calculation units that may generally be referred to as “nodes.” Here, the “nodes” may also be referred to as “neurons.” The one or more network functions may include one or more nodes, and the nodes (or neurons) constituting the one or more network functions may be connected to each other via one or more “links.”

In the object detection model, the one or more nodes connected via the links may be an input node and an output node in relation to each other. The concepts of input node and output node are relative. Any node that is an output node with respect to one node may be an input node with respect to another node, and vice versa. As described above, the relationship between an input node and an output node may be established on the basis of a link. One or more output nodes may be connected to one input node via links, and vice versa.

In the relationship between an input node and an output node connected via one link, a value of the output node may be determined on the basis of data input to the input node. Here, the link interconnecting the input node and the output node may have a weight. The weight may be variable and may be changed by a user or algorithm such that the object detection model may perform a desired function. For example, when one or more input nodes are connected to one output node via separate links, the output node may determine an output node value on the basis of values input to the input nodes connected to the output node and weights set for the links each corresponding to the input nodes.

As described above, in the object detection model, one or more nodes may be interconnected via one or more links to have the relationship of an input node and an output node. Characteristics of the object detection model may be determined in accordance with the number of nodes and links in the object detection model, connections between the nodes and the links, and weight values assigned to the links. For example, when two object detection models have the same number of nodes and links and different weights for the links, the two object detection models may be recognized as different from each other.

Some nodes included in the object detection model may constitute one layer on the basis of their distances from an initial input node. For example, a set of nodes having a distance of n from the initial input node may constitute an nth layer. The distance from the initial input node may be defined by the minimum number of links required to reach the corresponding node from the initial input node. However, this definition of a layer is arbitrary for description, and the order of a layer in the object detection model may be defined in a different way than described above. For example, a layer of nodes may be defined by the distance from a final output node.

The initial input node may be one or more nodes to which data is directly input without passing through links in the relationships with other nodes among the nodes in the object detection model. Alternatively, in the relationship between nodes based on a link in the network of the object detection model, the initial input node may be a node which does not have other input nodes connected via links. Similarly, the final output node may be one or more nodes which do not have output nodes in the relationship with other nodes among the nodes in the object detection model. Also, a hidden node may be a node constituting the object detection model other than the initial input node and the final output node. In the object detection model according to an exemplary embodiment of the present invention, the number of nodes of an input layer may be larger than the number of nodes of a hidden layer close to an output layer, and the number of nodes may decrease from the input layer to the hidden layer.

The object detection model may include one or more hidden layers. Hidden nodes of the hidden layers may use an output of a previous layer and outputs of nearby hidden nodes as inputs. The number of hidden nodes of each hidden layer may be uniform or variable. The number of nodes of the input layer may be determined on the basis of the number of data fields of input data and may be equal to or different from the number of hidden nodes. The input data input to the input layer may be computed by the hidden nodes of the hidden layers and output by a fully connected layer (FCL) which is the output layer.

In various embodiments, the object detection model may be a deep learning model.

The deep learning model (e.g., a deep neural network (DNN)) may be an object detection model that includes a plurality of hidden layers in addition to an input layer and an output layer. Latent structures of data may be identified using the DNN. In other words, it is possible to identify latent structures of photos, text, video, voice, and music (e.g., what objects are in the photos, what the content and emotion in the text are, what the content and emotion in the voice are, and the like).

The DNN may be, but is not limited to, a convolutional neural network (CNN), a recurrent neural network (RNN), an autoencoder, a generative adversarial network (GAN), a restricted Boltzmann machine (RBM), a deep belief network (DBN), a Q network, a U network, a Siamese network, or the like.

In various embodiments, the network functions may include an autoencoder. Here, the autoencoder may be an artificial neural network for outputting output data that is similar to input data.

The autoencoder may include at least one hidden layer, and an odd number of hidden layers may be disposed between an input layer and an output layer. The number of nodes of each layer may be reduced from that of the input layer to that of an intermediate layer, which is referred to as a bottleneck layer (encoding), and increased from that of the bottleneck layer to that of the output layer (symmetric to the input layer) symmetrically with the reduction. Nodes of a dimensionality reduction layer and nodes of a dimensionality recovery layer may or may not be symmetrical. Also, the autoencoder may perform non-linear dimensional reduction. The number of nodes of the input layer and the number of nodes of the output layer may correspond to the number of sensors remaining after the input data is preprocessed. In the autoencoder structure, the number of nodes of a hidden layer included in the encoder may decrease with an increase in the distance between the hidden layer and the input layer. When the number of nodes of the bottleneck layer (the layer having the smallest number of nodes and positioned between the encoder and the decoder) is extremely small, a sufficient amount of information may not be transmitted, and thus the number of nodes of the bottleneck layer may be maintained greater than or equal to a certain number (e.g., equal to or more than the half the number of nodes of the input layer).

Third, the planning operation performed by the computing device 100 may be an operation of generating a driving plan including a route, a speed, and the like for controlling the vehicle 10 on the basis of localization information derived through the localization operation and recognition information derived through the recognition operation and deriving driving plan information including information about the generated driving plan.

Lastly, the control operation performed by the computing device 100 may be an operation of determining and generating a control command for lateral control (directional control) and longitudinal control (speed control) for the vehicle 10 on the basis of the driving plan information derived through the planning operation and counterstrategy information and controlling an operation of the vehicle 10 in accordance with the determined and generated control command.

In various embodiments, the computing device 100 may be connected to the user terminal 200 via the network 400 and provide various kinds of information related to autonomous driving (e.g., a high-precision map of a certain region, a result of recognizing objects around the vehicle 10, a control command for autonomous driving, operation information of the vehicle 10 in accordance with the control command, and the like) to the user terminal 200.

The user terminal 200 may be any type of entity (entities) in a system having a mechanism for communication with the computing device 100. For example, the user terminal 200 may be a PC, a laptop computer, a mobile terminal, a smartphone, a tablet PC, a wearable device, or the like. In other words, the user terminal 200 may be any type of terminal that may access a wired or wireless network. Also, the user terminal 200 may be any computing device implemented by at least one of an agent, an application programming interface (API), and a plug-in. In addition, the user terminal 200 may include an application source and/or client application.

Here, the network 400 may be a connective structure for exchanging information between nodes such as a plurality of terminals and servers. Examples of the network 400 include a local area network (LAN), a wide area network (WAN), the world wide web (WWW), a wired or wireless data communication network, a telephone network, a wired or wireless television communication network, a controller area network (CAN), an Ethernet, and the like.

The wireless data communication network may be, but is not limited to, a Third Generation (3G) network, a Fourth Generation (4G) network, a Fifth Generation (5G) network, a Third Generation Partnership Project (3GPP) network, a Fifth Generation Partnership Project (5GPP) network, a Long Term Evolution (LTE) network, a World Interoperability for Microwave Access (WiMAX) network, a Wi-Fi network, the Internet, a LAN, a wireless LAN, a WAN, a personal area network (PAN), a radio frequency (RF) network, a Bluetooth network, a near-field communication (NFC) network, a satellite broadcast network, an analog broadcast network, a digital multimedia broadcasting (DMB) network, and the like.

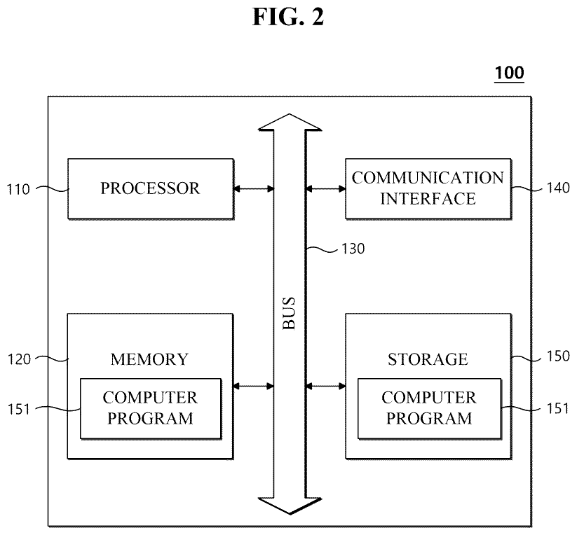

In an exemplary embodiment, the external server 300 may be connected to the computing device 100 via the network 400 and may store and manage various kinds of information and data required for the computing device 100 to perform a method of detecting an object in real time on the basis of a lidar point cloud or collect, store, and manage various kinds of information and data that is derived when the computing device 100 performs a method of detecting an object in real time on the basis of a lidar point cloud. For example, the external server 300 may be, but is not limited to, a storage server that is separately provided outside the computing device 100. A hardware configuration of the computing device 100 for performing a method of detecting an object in real time on the basis of a lidar point cloud will be described below with reference to FIG. 2.

FIG. 2 shows a hardware block diagram of a computing device that performs a method of detecting an object in real time on the basis of a point cloud according to another exemplary embodiment of the present invention.

Referring to FIG. 2, in various embodiments, the computing device 100 may include at least one processor 110, a memory 120 on which a computer program 151 executed by the processor 110 is loaded, a bus 130, a communication interface 140, and a storage 150 that stores the computer program 151. Here, FIG. 2 only shows components related to an embodiment of the present invention. Therefore, it is apparent to those of ordinary skill in the art that other general-purpose components may be further included in addition to the components shown in FIG. 2.

The processor 110 controls overall operations of each element of the computing device 100. The processor 110 may include a central processing unit (CPU), a microprocessor unit (MPU), a microcontroller unit (MCU), a graphics processing unit (GPU), or any type of processor well known in the technical field of the present invention.

Also, the processor 110 may perform computation on at least one application or program for performing methods according to exemplary embodiments of the present invention, and the computing device 100 may include one or more processors.

In various embodiments, the processor 110 may further include a random access memory (RAM) (not shown) and a read-only memory (ROM) (not shown) for temporarily and/or permanently storing signals (or data) processed in the processor 110. The processor 110 may be implemented in the form of a system on chip (SoC) including at least one of a graphics processor, a RAM, and a ROM.

The memory 120 stores various kinds of data, instructions, and/or information. The memory 120 may load the computer program 151 from the storage 150 to perform methods or operations in accordance with various embodiments of the present invention. When the computer program 151 is loaded to the memory 120, the processor 110 may execute one or more instructions constituting the computer program 151 to perform the methods or operations. The memory 120 may be embodied as a volatile memory, such as a RAM, but the technical scope of the present invention is not limited thereto.

The bus 130 provides a communication function between the components of the computing device 100. The bus 130 may be implemented as various kinds of buses such as an address bus, a data bus, a control bus, and the like.

The communication interface 140 supports wired and wireless Internet communication of the computing device 100. The communication interface 140 may support various communication methods other than Internet communication. To this end, the communication interface 140 may include a communication module well known in the technical field of the present invention. In some embodiments, the communication interface 140 may be omitted.

The storage 150 may store the computer program 151 non-temporarily. When a process of detecting an object in real time on the basis of a lidar point cloud is performed through the computing device 100, the storage 150 may store various kinds of information that are necessary to provide the process of detecting an object in real time on the basis of a lidar point cloud.

The storage 150 may include a non-volatile memory, such as a ROM, an erasable programmable ROM (EPROM), an electrically erasable programmable ROM (EEPROM), a flash memory, or the like, a hard disk drive, a detachable disk, or any type of computer-readable recording medium well known in the technical field to which the present invention pertains.

The computer program 151 may include one or more instructions causing the processor 110 to perform methods or operations in accordance with various embodiments of the present invention when the computer program 151 is loaded to the memory 120. In other words, the processor 110 may execute the one or more instructions to perform the methods or operations in accordance with various embodiments of the present invention.

In an exemplary embodiment, the computer program 151 may include one or more instructions for performing a method of detecting an object in real time on the basis of a lidar point cloud, the method including an operation of generating a feature map on the basis of a point cloud which is generated by scanning a certain region through a lidar sensor and an operation of deriving an object detection result by inputting the generated feature map to a pretrained object detection model.

The operations of the method or algorithm described above in connection with embodiments of the present invention may be implemented directly by hardware, a software module executed by hardware, or a combination thereof. The software module may be in a RAM, a ROM, an EPROM, an EEPROM, a flash memory, a hard disk, a detachable disk, a compact disc (CD)-ROM, or any type of computer-readable recording medium well known in the technical field to which the present invention pertains.

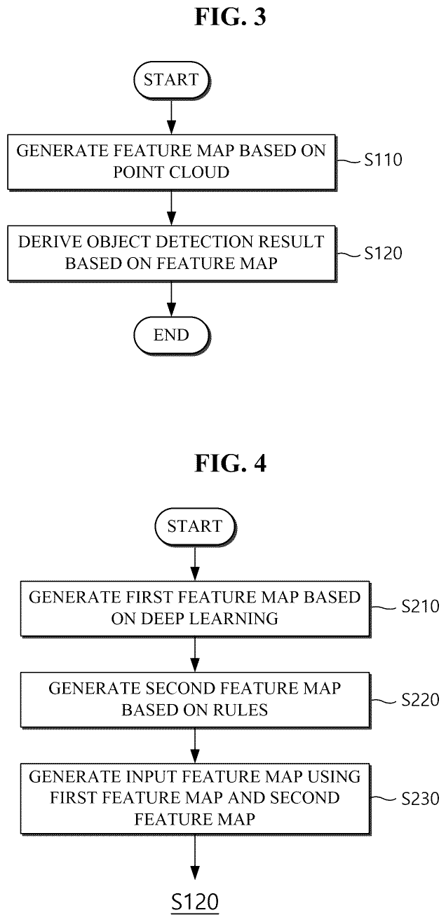

Components of the present invention may be embodied in the form of a program (or application) and stored in a medium to be executed in combination with a computer which is hardware. The components of the present invention may be implemented by software programming or software elements, and similarly, embodiments may be implemented in a programming or scripting language, such as C, C++, Java, an assembler, or the like, to include various algorithms implemented as a combination of data structures, processes, routines, or other programming elements. Functional aspects may be embodied as an algorithm executable by one or more processors. The method of detecting an object in real time on the basis of a lidar point cloud performed by the computing device 100 will be described below with reference to FIG. 3.

FIG. 3 is a flowchart illustrating a method of detecting an object in real time on the basis of a lidar point cloud according to still another exemplary embodiment of the present invention.

Referring to FIG. 3, in operation S110, the computing device 100 may generate a feature map on the basis of a point cloud which is generated by scanning a certain region.

In various embodiments, the computing device 100 may be connected to the vehicle 10 which travels in the certain region, acquire point cloud which is generated by scanning the certain region through the lidar sensor of the vehicle 10 from the vehicle 10, and generate a feature map by processing the acquired point cloud.

Here, the lidar sensor may be installed on the roof of the vehicle 10 and perform 360-degree scanning but is not limited thereto. Also, point cloud collected by the lidar sensor of the vehicle 10 may be, but is not limited to, a set of three-dimensional (3D) points collected by performing 360-degree scanning on the basis of the vehicle 10. A feature map generation method performed by the computing device 100 will be described in detail below with reference to FIGS. 4 to 15.

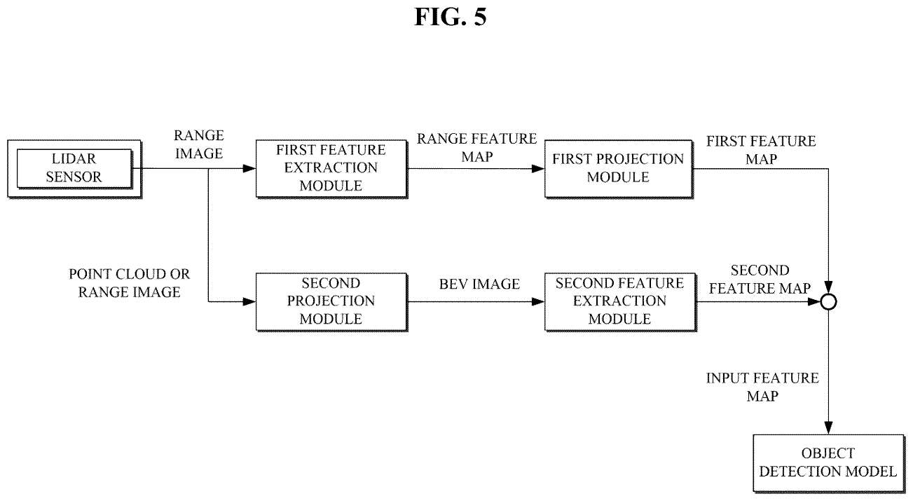

FIG. 4 is a flowchart illustrating an input feature map generation method according to a first exemplary embodiment, and FIG. 5 is a diagram illustrating the input feature map generation method according to the first exemplary embodiment.

Referring to FIG. 4, in the input feature map generation method according to the first exemplary embodiment, a first feature map generation operation S210 is performed, and then a second feature map generation operation S220 is performed.

However, this is merely intended to easily describe the input feature map generation method according to the first exemplary embodiment, and the present invention is not limited thereto. The first feature map generation operation S210 and the second feature map generation operation S220 may be simultaneously performed in parallel, or in some cases, the first feature map generation operation S210 may be performed after the second feature map generation operation S220.

Referring to FIGS. 4 and 5, in operation S210, the computing device may generate a first feature map (1st bird's eye view (BEV) feature map) using point cloud which is generated in accordance with a certain region.

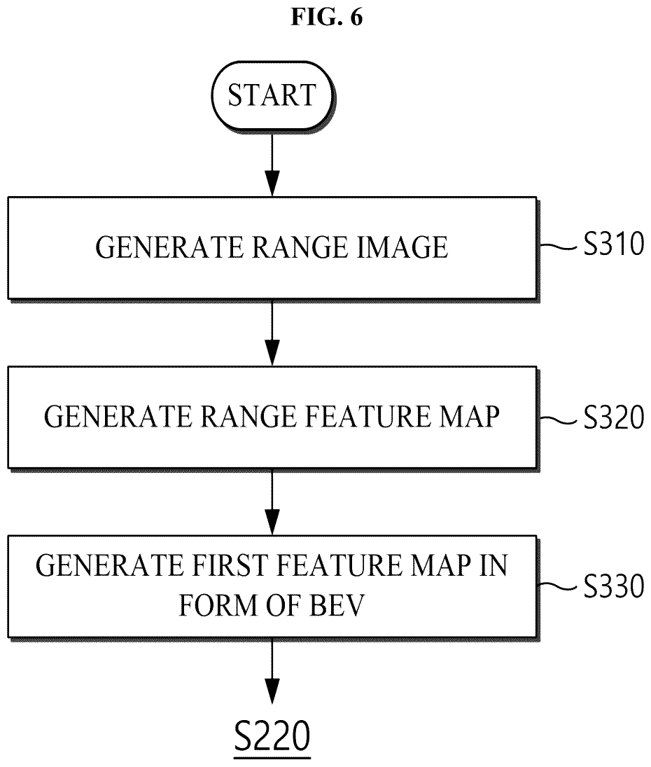

In various embodiments, the computing device 100 may generate a first feature map by processing point cloud on the basis of deep learning. A detailed method of generating a first feature map will be described below with reference to FIG. 6.

FIG. 6 is a flowchart illustrating a method of generating a first feature map according to various embodiments.

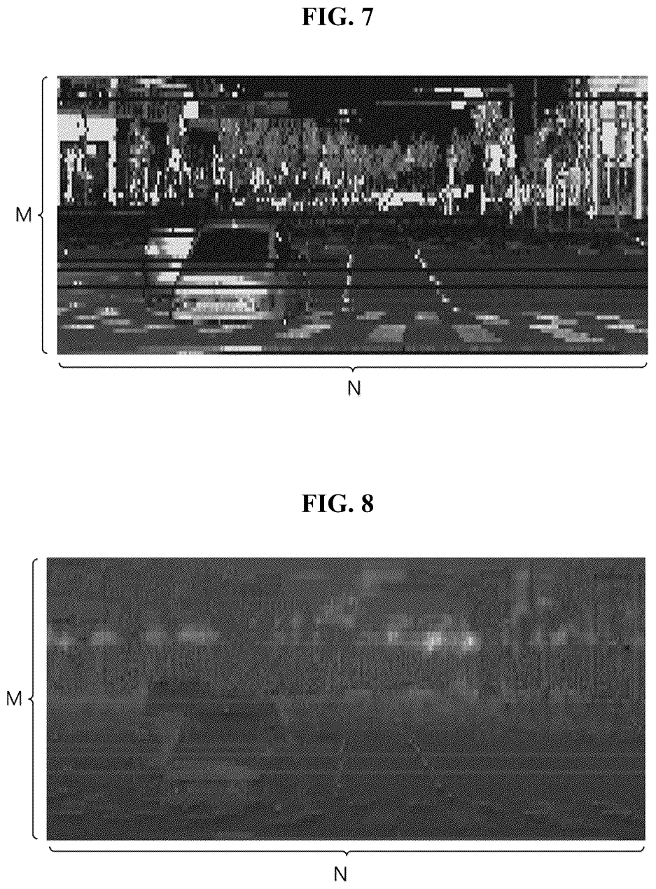

Referring to FIG. 6, in operation S310, the computing device 100 may generate a range image (e.g., FIG. 7) on the basis of a point cloud.

Here, the range image may be an image expressing range information of 3D points included in the point cloud in two dimensions. For example, the range image may be, but is not limited to, an image of 3D points included in the point cloud data and viewed on the basis of the lidar sensor (or the vehicle 10 in which the lidar sensor is installed), that is, a range view. As an example, point cloud collected by the lidar sensor installed on the roof of the vehicle 10 may be data expressing 3D points included in a cylindrical space, and a range image that is generated by processing the point cloud with a range view may be data expressing two-dimensional (2D) points included in a plane corresponding to the lateral surface of the cylinder.

In various embodiments, a range image may be generated by converting 3D points included in point cloud into 2D points on a YZ plane on the basis of a range of the vehicle 10 or the lidar sensor of the vehicle 10.

More specifically, the computing device 100 may determine a size of a range image to be generated on the basis of attributes of the lidar sensor. For example, the computing device 100 may determined a size of a range image to be generated on the basis of the number of channels and operation intervals of the lidar sensor.

Here, a size of pixels included in the range image has a fixed value, and thus the number of pixels included in the range image is determined in accordance with the size of the range image. Accordingly, determining a size of a range image to be generated may be construed as, but is not limited to, determining a number N of pixels to be horizontally included in the range image and a number M of pixels to be vertically included therein.

Subsequently, the computing device 100 may convert 3D points included in the point cloud data into 2D points on the YZ plane. For example, the computing device 100 may calculate a range r, a horizontal angle θ, and a vertical angle φ corresponding to each 3D point by converting the 3D point included in the point cloud into a polar coordinate system and convert the 3D point (x, y, z) in a 3D space into a 2D point (y, z) on the YZ plane by setting the horizontal angle θ of the 3D point as a Y coordinate value and setting the vertical angle φ of the 3D point as a Z coordinate value. However, a method of converting 3D points into 2D points is not limited thereto.

Subsequently, the computing device 100 may define a region having the same size (N*M) as a range image to be generated on the YZ plane and set pixel values of a plurality of pixels included in the region defined on the YZ plane to generate a range image in the form of a 2D tensor with a size of N*M. For example, the computing device 100 may set a range r corresponding to a 2D point belonging to each of the plurality of pixels (e.g., the range r calculated in the process of converting the 3D point before the 2D conversion into the polar coordinate system) as a pixel value of each of the plurality of pixels, but a method of setting pixel values of pixels is not limited thereto.

In various embodiments, the computing device 100 may record information about the 3D points included in the point cloud data in the range image generated in the form of a 2D tensor in accordance with the above method.

Here, when a plurality of pieces of information about 3D points are included in the point cloud data, the computing device 100 may generate range images in the form of a plurality of 2D tensors by recording the plurality of pieces of information about each of the 3D points in each of range images having the form of different 2D tensors in accordance with kinds of information and generate a range image in the form of one 3D tensor by combining the plurality of range images having the form of a plurality of 2D tensors.

As an example, when information about the 3D points includes three pieces of position information (e.g., an X coordinate value, a Y coordinate value, and a Z coordinate value) and one piece of intensity information (e.g., intensity with which a laser beam output from the lidar sensor is reflected back by an object), the computing device 100 may generate range images in the form of four 2D tensors by separately recording X coordinate values, Y coordinate values, Z coordinate values, and intensity values of the 3D points in range images having the form of different 2D tensors with a size of N*M and generate a range image in the form of one 3D tensor with a size of 4*N*M by combining the range images having the form of four 2D tensors.

In operation S320, the computing device 100 may generate a range feature map (e.g., FIG. 8) on the basis of the range image generated through operation S310.

In various embodiments, the computing device 100 may extract feature information by analyzing the range image on the basis of a first feature extraction module (e.g., 1^{st} feature extractor) and generate a range feature map using the feature information.

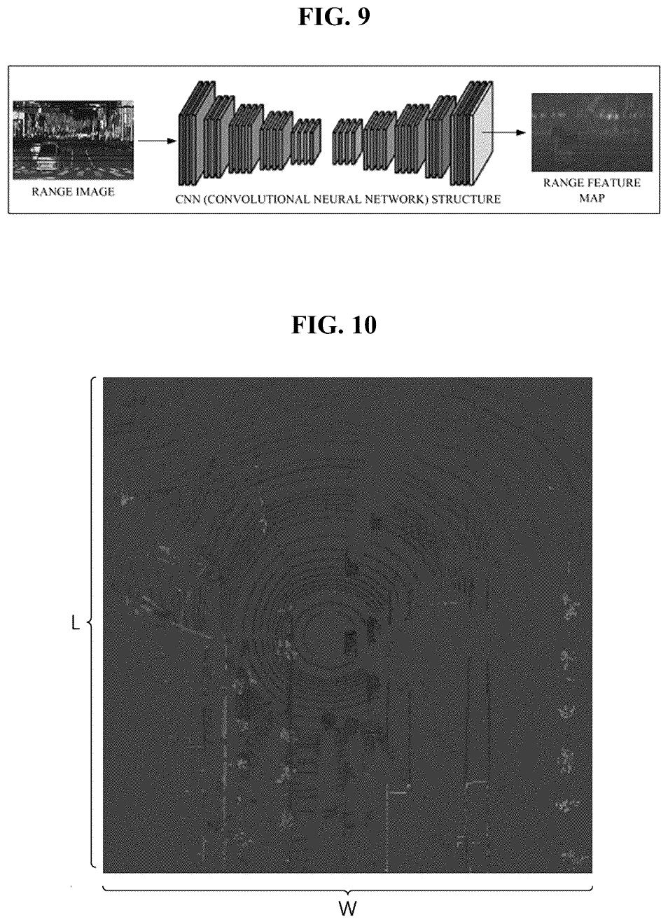

The first feature extraction module may be, but is not limited to, a deep learning model having a convolutional neural network (CNN) structure as shown in FIG. 9. For example, when a range image is input to the first feature extraction module, a convolution layer and a pooling layer included in the first feature extraction module may extract a feature from each stage-specific range image as a latent representation while gradually reducing a width, a height, and/or an area of the range image, and generate a range feature map by recovering the original range images from the latent expressions extracted in stages and combining the original range images.

In various embodiments, the computing device 100 may generate a range feature map in the form of one 3D tensor using a range image having the form of one 3D tensor.

When the first feature extraction module processes a range image in which each pixel includes K pieces of information, that is, a range image having the form of a 3D tensor with a size of K*N*M, as described above, K pieces of information recorded in each pixel included in the range image is replaced with a first number feat_R of latent representations by the first feature extraction module. Accordingly, the range image having the form of the 3D tensor with a size of K*N*M is converted into a range feature map having the form of a 3D tensor with a size of (feat_R)*N*M.

Here, the first number feat_R is the number of latent representations recorded in each of a plurality of pixels included in the range feature map and may be, but is not limited to, a value determined in a process of training the first feature extraction module.

In operation S330, the computing device 100 may generate a first feature map (1^{st} BEV feature map) (e.g., FIG. 10) on the basis of the range feature map which is generated through operation S320.

In various embodiments, the computing device 100 may generate a first feature map in the form of a BEV by projecting a range feature map generated on the basis of the YZ plane through a first projection module (1^{st} projector).

Here, the first feature map having the form of a BEV may be, but is not limited to, a feature map corresponding to a top-down view in which the vehicle 10 or the lidar sensor installed in the vehicle 10 is centered.

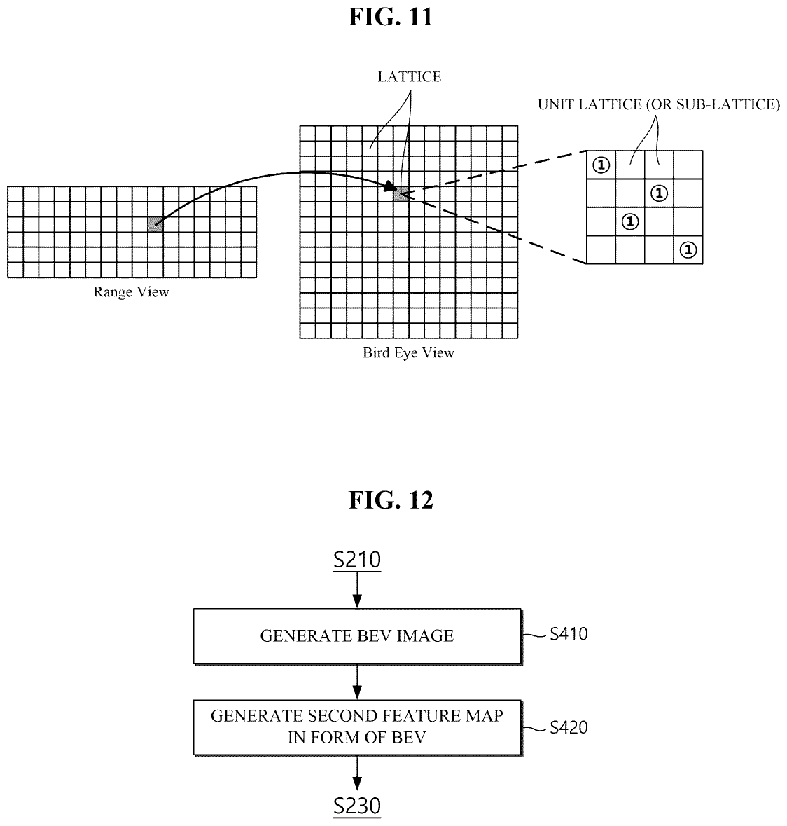

More specifically, referring to FIG. 11, the computing device 100 may first generate a feature map template including a plurality of lattices that are generated by latticing a region having a preset size on an XY plane.

Here, sizes of the plurality of lattices are preset to be the same, and thus the number of lattices included in the feature map template is determined on the basis of a size of the feature map template. Therefore, the size of the feature map template may be expressed as, but is not limited to, L*W which is the product of a horizontal number W of lattices and a vertical number L of lattices.

Subsequently, the computing device 100 may record feature information (a latent expression) recorded in each of the plurality of pixels included in the range feature map in each of the plurality of lattices included in the feature map template to generate a first feature map.

Here, when two or more pieces of feature information correspond to one lattice, the computing device 100 may record an average value of the two or more pieces of feature information in the lattice, but a method of recording two or more pieces or feature information in one lattice is not limited thereto.

In various embodiments, the computing device 100 may generate a first feature map in the form of a 3D tensor using a range feature map having the form of a 3D tensor. For example, when the first number feat_R of pieces of feature information are recorded in each pixel of a range feature map, that is, when the range feature map has the form of a 3D tensor with a size of (feat_R)*N*M, the computing device 100 may generate first feature maps in the form of the first number feat_R of 2D tensors by recording the first number feat_R of pieces of feature information on different feature map templates and generate a first feature map in the form of a 3D tensor with a size of (feat_R)*L*W by combining the first feature maps having the form of the first number feat_R of 2D tensors.

When a first feature map is generated in this way, the number of pieces of feature information included in an image does not change even with a change in the size of the image caused by a change in viewpoint. Accordingly, it is possible to prevent the loss of information from degrading object detection performance.

In various embodiments, the computing device 100 may generate a plurality of unit lattices (or sub-lattices) from each of the plurality of lattices by dividing the lattice to a certain size and record feature information of points corresponding to each of the plurality of lattices in the plurality of unit lattices included in the plurality of lattices. For example, the computing device 100 may generate 16 unit lattices by dividing each of the plurality of lattices to a size of 4×4 and record feature information of points corresponding to a specific lattice in 16 unit lattices generated by dividing the specific lattice.

In this case, for each of the plurality of unit lattices generated by dividing the specific lattice, the computing device 100 may record only feature information of one point corresponding to each of the plurality of unit lattices. Here, when two or more points correspond to a specific unit lattice, the computing device 100 may select any one of the two or more points and record only feature information of the selected point in the specific unit lattice.

To change a viewpoint (e.g., converting an image of the YZ plane into an image of the XY plane), a viewpoint change method according to the related art involves a computational task of sequentially converting a plurality of points each corresponding to a plurality of pixels included in an image of which viewpoint will be changed, which limits computational speed.

To parallelly perform computational tasks for multiple pixel regions, it is necessary to know the number of lattices to be processed and the number of points stored in each lattice in advance. In various embodiments of the present invention, as described above, feature information to be recorded in one lattice is recorded in multiple unit lattices in a distributed manner, and the number of pieces of feature information recorded in each unit lattice is limited. Accordingly, it is possible to parallelly perform computational tasks for several lattice regions.

Also, when one lattice is divided into multiple unit lattices and feature information to be recorded in the lattice is recorded in the multiple unit lattices in a distributed manner, information can be recorded spatially (geometrically) uniformly (evenly) without bias, which can lead to more effective object detection.

Referring back to FIGS. 4 and 5, in operation S220, the computing device 100 may generate a second feature map (2^{nd} BEV feature map) using the point cloud which is generated in accordance with the certain region.

In various embodiments, the computing device 100 may generate a second feature map by processing the point cloud on the basis of rules. A detailed method of generating a second feature map will be described below with reference to FIG. 12.

FIG. 12 is a flowchart illustrating a method of generating a second feature map according to various embodiments.

Referring to FIG. 12, in operation S410, the computing device 100 may generate a BEV image by projecting the point cloud or the range image which is generated on the basis of the point cloud on the XY plane.

In various embodiments, the computing device 100 may generate a BEV image by projecting the point cloud or the range image which is generated on the YZ plane on the basis of the point cloud on the XY plane through a second projection module (2^{nd} projector).

Here, the first projection module (1^{st} projector) and the second projection module (2^{nd} projector) are described as different projection modules but are not limited thereto. The first projection module (1^{st} projector) and the second projection module (2^{nd} projector) may be the same model but are not limited thereto.

More specifically, the computing device 100 may first generate a BEV image template including a plurality of lattices that are generated by latticing a region having a preset size on the XY plane.

Here, sizes of the plurality of lattices are preset to be the same, and thus the number of lattices included in the BEV image template is determined on the basis of a size of the BEV image template. Therefore, like the size of the feature map template, the size of the BEV image template may be expressed as, but is not limited to, L*W which is the product of the horizontal number W of lattices and the vertical number L of lattices.

Subsequently, the computing device 100 may record information about the points included in the point cloud or the range image in each of the plurality of lattices included in the BEV image template to generate a BEV image.

In various embodiments, when a plurality of pieces of information about the points are included in the point cloud or the range image, the computing device 100 may generate BEV images having the form of a plurality of 2D tensors by recording the plurality of pieces of information in different BEV image templates in accordance with kinds of information and generate a BEV image in the form of one 3D tensor by combining the BEV images having the form of a plurality of 2D tensors.

For example, when information about the 3D points included in the point cloud includes three pieces of location information (e.g., an X coordinate value, a Y coordinate value, and a Z coordinate value) and one piece of intensity information (e.g., intensity with which a laser beam output from the lidar sensor is reflected back by an object), the computing device 100 may generate BEV images in the form of four 2D tensors by separately recording X coordinate values, Y coordinate values, Z coordinate values, and intensity values of the 3D points in BEV image templates having the form of different 2D tensors with a size of L*W and generate a BEV image in the form of one 3D tensor with a size of 4*L*W by combining the BEV images having the form of four 2D tensors.

In operation S420, the computing device 100 may generate a second feature map (2^{nd} BEV feature map) (e.g., FIG. 10) on the basis of the BEV image generated through operation S410.

In various embodiments, the computing device 100 may extract feature information by analyzing the BEV image on the basis of a second feature extraction module (2^{nd} feature extractor) and generate a second feature map in the form of a BEV using the feature information.

Here, the second feature extraction module may be, but is not limited to, a rule-based model for extracting features corresponding to preset rules.

Also, features extracted by the rule-based second feature extraction module may include, but are not limited to, the number of points corresponding to each of the plurality of lattices included in the BEV image, whether the number of points is at least one (whether a point is in each lattice), an average and standard deviation of the locations of the points, and intensities of the points, or information calculated on the basis of them. For example, the computing device 100 may extract feature information from each of the plurality of lattices included in the BEV image and generate a second feature map by recording the extracted feature information in each of the plurality of lattices.

Here, the second feature map may be generated for the purpose of making up for information that is lost during the process of generating the first feature map on the basis of the feature information extracted by the first feature extraction module. In other words, information that is lost during a feature map generation process can be minimized by combining the first feature map, which is generated on the basis of the feature information extracted by the deep-learning-based first feature extraction module, and the second feature map which is generated on the basis of the feature information extracted by the rule-based second feature extraction module. In this way, detection performance can be improved, which leads to accurate object detection.

In various embodiments, the computing device 100 may record the feature information derived by analyzing the BEV image in the plurality of lattices included in the feature map template to generate a second feature map.

Here, when two or more pieces of feature information correspond to one lattice, the computing device 100 may record an average value of the two or more pieces of feature information in the lattice, but information recorded in one lattice is not limited thereto.

In various embodiments, the computing device 100 may generate a second feature map in the form of a 3D tensor using the BEV image having the form of a 3D tensor. For example, when a second number feat_BEV of pieces of feature information are extracted by analyzing the BEV image having the form of a 3D tensor on the basis of rules, the computing device 100 may generate second feature maps in the form of the second number feat_BEV of 2D tensors by recording the second number feat_BEV of pieces of feature information on different feature map templates and generate a second feature map in the form of one 3D tensor with a size of (feat_BEV)*L*W by combining the second feature maps having the form of the second number feat_BEV of 2D tensors. In an exemplary embodiment, the second number feat_BEV may be, but is not limited thereto, a value predefined on the basis of rules.

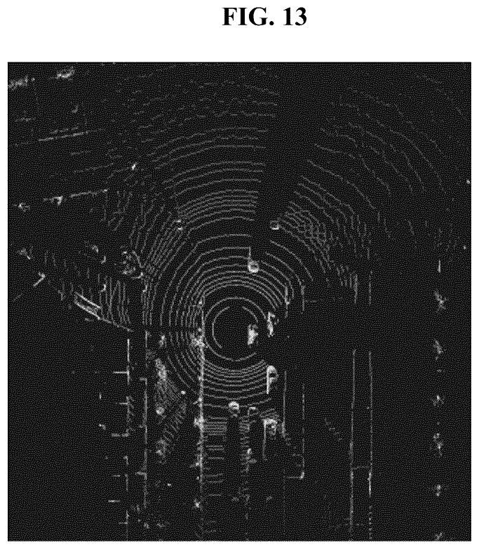

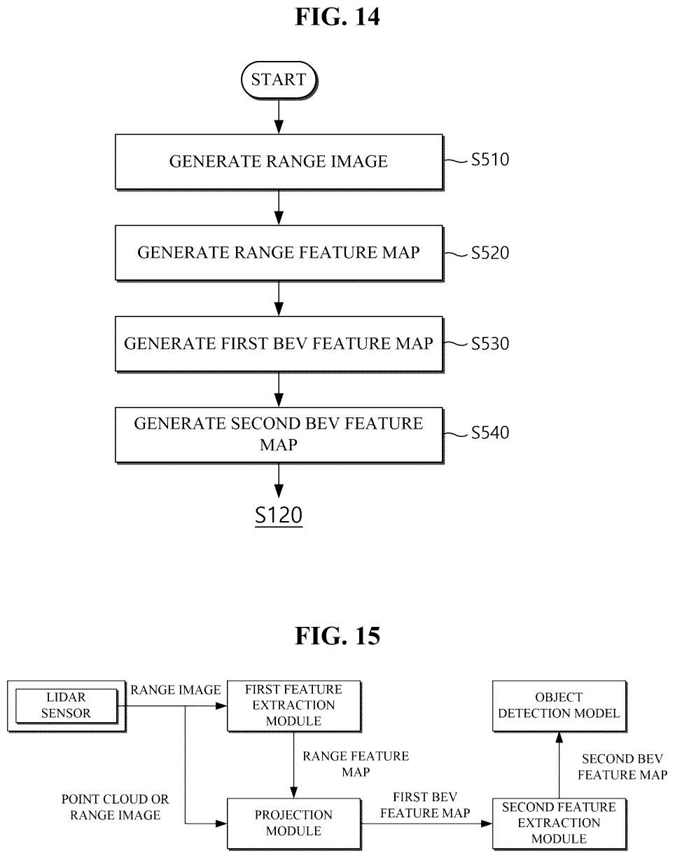

Referring back to FIGS. 4 and 5, in operation S230, the computing device 100 may generate an input feature map (BEV pseudo image) (e.g., FIG. 13) of the object detection model (object detector) by combining the first feature map generated through operation S210 and the second feature map generated through operation S220. For example, when a first feature map having the form of a 3D tensor with a size of (feat_R)*L*W and a second feature map having the form of a 3D tensor with a size of (feat_BEV)*L*W are generated in accordance with the above-described method, the computing device 100 may generate an input feature map in the form of a 3D tensor with a size of (feat_R+feat_BEV)*L*W by combining the first feature map and the second feature map. However, an input feature map generation method is not limited thereto. An input feature map generation method according to a second exemplary embodiment will be described below with reference to FIGS. 14 and 15.

FIG. 14 is a flowchart illustrating the input feature map generation method according to the second exemplary embodiment, and FIG. 15 is a diagram illustrating the input feature map generation method according to the second exemplary embodiment.

Referring to FIGS. 14 and 15, in operation S510, the computing device 100 may generate a range image on the basis of a point cloud. Here, a range image generation operation performed by the computing device 100 may be implemented similarly to the range image generation operation performed in operation S310 of FIG. 6, but is not limited thereto.

In operation S520, the computing device 100 may generate a range feature map using the range image that is generated through operation S510. Here, a range feature map generation operation performed by the computing device 100 may be implemented similarly to the range feature map generation operation performed in operation S320 of FIG. 6, but is not limited thereto.

In operation S530, the computing device 100 may generate a first BEV feature map using the point cloud or the range image and the range feature map generated through operation S520.

In various embodiments, the computing device 100 may generate a first BEV feature map by combining the point cloud or the range image and the range feature map and then projecting the combination on the XY plane through a projector.

For example, when the range image generated on the basis of the point cloud has the form of a 3D tensor with a size of K*N*M and a range feature map generated on the basis of the range image has the form of a 3D tensor with a size of (feat_R)*N*M, the computing device 100 may generate an image in the form of a 3D tensor with a size of (feat_R+K)*N*M by combining the range image having the form of a 3D tensor and the range feature map having the form of a 3D tensor and generate a first BEV feature map in the form of a 3D tensor with a size of (feat_R+K)*L*W by projecting the image having the form of a 3D tensor on the XY plane. Here, a detailed method of generating a first BEV feature map in the form of a 3D tensor on the basis of an image in the form of a 3D tensor which is generated by combining a range image having the form of a 3D tensor and a range feature map having the form of a 3D tensor may be implemented similarly to operation S420 of FIG. 12, but is not limited thereto.

In operation S540, the computing device 100 may generate a second BEV feature map as an input feature map of the object detection model using the first BEV feature map that is generated through operation S530.

For example, the computing device 100 may extract a third number feat_BEV+feat_R of pieces of feature information by analyzing the first BEV feature map having the form of a 3D tensor with a size of (feat_R+4)*L*W through the rule-based second feature extraction module, generate second BEV feature maps in the form of the third number feat_BEV+feat_R of 2D tensors by recording the third number feat_BEV+feat_R of pieces of extracted feature information in a plurality of lattices included in different feature map templates L*W, and generate a second BEV feature map in the form of a 3D tensor with a size of (feat_BEV+feat_R)*L*W by combining the second BEV feature maps having the form of the third number feat_BEV+feat_R of 2D tensors.

Referring back to FIG. 3, in operation S120, the computing device 100 may derive an object detection result on the basis of the feature map generated through operation S110.

In various embodiments, the computing device 100 may determine one of a plurality of predefined classes to which an object belongs by analyzing the feature map through a deep-learning-based image analysis model and derive an object detection result including information about the determined class and information about the object.

Here, when the object is determined to be a pedestrian in accordance with the class to which the object belongs, the computing device 100 may derive an object detection result including location information of the pedestrian.

Meanwhile, when the object is determined to be a vehicle in accordance with the class to which the object belongs, the computing device 100 may derive an object detection result including information about a location of the vehicle and a distance from the vehicle.

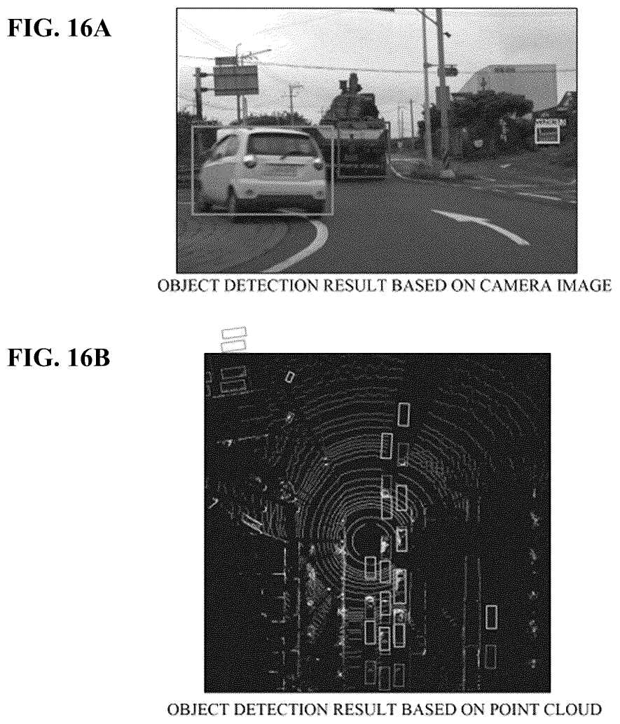

Referring to FIGS. 16A and 16B, with a camera-based object detection method according to the related art, it is difficult to accurately detect objects because objects overlap each other as shown in FIG. 16A. On the other hand, with an object detection method according to various embodiments of the present invention, it is possible to detect objects more accurately because objects do not overlap as shown in FIG. 16B.

A method of detecting an object in real time on the basis of a lidar point cloud has been described above with reference to the flowcharts shown in the drawings. For simple description, the method of detecting an object in real time on the basis of a lidar point cloud has been illustrated and described as a series of blocks. However, the present invention is not limited to the order of blocks, and some blocks may be performed simultaneously or in a different order from that illustrated and described herein. In addition, new blocks not described in this specification and drawings may be added, or some blocks may be omitted or changed.

According to various embodiments of the present invention, it is possible to achieve real-time object detection and ensure superior detection performance and speed by generating a feature map on the basis of a point cloud collected through a lidar sensor and detecting an object on the basis of the feature map.

Also, a 2D feature map is generated in the form of a BEV on the basis of a point cloud including 3D points, and object detection is performed on the basis of the 2D feature map. Accordingly, the complexity of data to be analyzed is lowered, which can remarkably reduce the amount of computation.

Further, two feature maps that are generated in accordance with different methods during a process of generating a feature map on the basis of a point cloud are combined. Accordingly, information that is lost during the process of generating a feature map can be made up for, and in this way, object detection performance can be notably improved.

In addition, it is possible to remarkably reduce a time taken for an object detection process by dramatically increasing the speed of a process of generating data in the form of a BEV through a projection algorithm in which characteristics of a computing device are taken into consideration.

Effects of the present invention are not limited to those described above, and other effects which have not been described above will be clearly understood by those skilled in the art from the above description.

Although exemplary embodiments of the present invention have been described above with reference to the accompanying drawings, those of ordinary skill in the art to which the present invention pertains will understand that the present invention may be implemented in other specific forms without changing the technical spirit or essential features thereof. Therefore, it is to be understood that the above-described embodiments are illustrative in all aspects and not limiting.

What is claimed is:

1. A method of detecting an object in real time on the basis of a lidar point cloud, which is performed by a computing device, the method comprising:
generating a feature map on the basis of a point cloud which is generated by scanning a certain region through a lidar sensor; and
deriving an object detection result by inputting the generated feature map to a pretrained object detection model.

2. The method of claim 1, wherein the generating of the feature map comprises:
generating a first feature map by processing the point cloud on the basis of deep learning;
generating a second feature map by processing the point cloud on the basis of rules; and
generating an input feature map of the pretrained object detection model by combining the generated first feature map and the generated second feature map.

3. The method of claim 2, wherein the generating of the first feature map comprises:
generating a range image by converting three-dimensional (3D) points included in the point cloud into two-dimensional (2D) points on a YZ plane on the basis of a range of the lidar sensor or a vehicle in which the lidar sensor is installed;
extracting feature information by analyzing the generated range image on the basis of a deep-learning-based feature extraction module and generating a range feature map using the extracted feature information; and
generating a first feature map in a form of a bird's eye view (BEV) by projecting the generated range feature map on an XY plane.

4. The method of claim 3, wherein the generating of the first feature map in the form of a BEV comprises:
generating a plurality of lattices by latticing a region having a preset range on the XY plane; and
recording feature information of points included in the generated range feature map in each of the plurality of lattices.

5. The method of claim 4, wherein the recording of the feature information of the points in each of the plurality of lattices comprises:
generating a plurality of unit lattices for each of the plurality of generated lattices by dividing the lattice to a certain size; and
recording feature information of points, which are included in the generated range feature map and correspond to a specific one of the plurality of lattices, in each of the plurality of unit lattices generated by dividing the specific lattice.

6. The method of claim 5, wherein the recording of the feature information in each of the plurality of unit lattices generated by dividing the specific lattice comprises recording only feature information of one point corresponding to the plurality of unit lattices generated by dividing the specific lattice and, when two or more points correspond to a specific unit lattice, recording only feature information of any one of the two or more points in the specific unit lattice.

7. The method of claim 3, wherein the generating of the range image comprises determining a size of a range image to be generated on the basis of an attribute of the lidar sensor which includes at least one of the number of channels and laser radiation intervals.

8. The method of claim 3, wherein the generating of the range image comprises:
generating a range image in the form of a 2D tensor by converting the 3D points included in the point cloud into 2D points on the YZ plane;
generating range images in the form of a plurality of 2D tensors by recording a plurality of pieces of information about each of the 3D points in each of range images having different forms of 2D tensors in accordance with kinds of information; and
generating a range image in the form of one 3D tensor by combining the range images generated in the form of the plurality of 2D tensors,
the generating of the range feature map comprises generating a range feature map in the form of one 3D tensor using the generated range image having the form of one 3D tensor, and
the generating of the first feature map comprises generating a first feature map in the form of a 3D tensor using the generated range feature map having the form of one 3D tensor.

9. The method of claim 2, wherein the generating of the second feature map comprises:
generating a bird's eye view (BEV) image by projecting the point cloud or a range image generated on the basis of the point cloud on an XY plane; and
extracting feature information by analyzing the generated BEV image on the basis of a rule-based feature extraction module and generating a second feature map in the form of a BEV using the extracted feature information.

10. The device of claim 9, wherein the generating of the BEV image comprises:
generating a plurality of lattices by latticing a region having a preset size on the XY plane; and
recording feature information of points included in the point cloud or the range image generated on the basis of the point cloud in each of the plurality of generated lattices.

11. The device of claim 1, wherein the generating of the feature map comprises:
generating a range image by converting three-dimensional (3D) points included in the point cloud into two-dimensional (2D) points on a YZ plane on the basis of a range of the lidar sensor or a vehicle in which the lidar sensor is installed;
extracting first feature information by analyzing the generated range image on the basis of a deep-learning-based feature extraction module and generating a range feature map using the extracted first feature information;
combining the point cloud or the generated range image with the generated range feature map and then projecting the combination on an XY plane to generate a first BEV feature map; and
extracting second feature information by analyzing the generated first BEV feature map through a rule-based feature extraction module and generating a second BEV feature map as an input feature map of the pretrained object detection model using the extracted second feature information.

12. The device of claim 1, wherein the pretrained object detection model includes a deep-learning-based image analysis model, and
the deriving of the object detection result comprises:
determining one of a plurality of predefined classes to which an object belongs by analyzing the generated feature map through the deep-learning-based image analysis model and deriving an object detection result including information about the determined class and information about the object,
wherein, when the object is a pedestrian, the information about the object includes location information of the pedestrian, and
when the object is a vehicle, the information about the object includes information about a location of the vehicle and a distance from the vehicle.

13. A computing device for performing a method of detecting an object in real time on the basis of a lidar point cloud, the computing device comprising:
a processor;
a network interface;
a memory; and
a computer program loaded to the memory and executed by the processor,
wherein the computer program comprises:
an instruction of generating a feature map on the basis of a point cloud which is generated by scanning a certain region through a lidar sensor; and
an instruction of deriving an object detection result by inputting the generated feature map to a pretrained object detection model.

14. A recording medium in which a computer program for causing a computing device to perform a method of detecting an object in real time on the basis of a lidar point cloud is stored, wherein the method comprising:
generating a feature map on the basis of a point cloud which is generated by scanning a certain region through a lidar sensor; and
deriving an object detection result by inputting the generated feature map to a pretrained object detection model.
